(19) United States
(12) Patent Application Publication
(10) Pub. No.: US 2016/0269844 A1
(43) Pub. Date: Sep. 15, 2016

(54) STEREO HEADSET, TERMINAL, AND AUDIO SIGNAL PROCESSING METHODS THEREOF

(71) Applicant: Huawei Technologies Co., Ltd., Shenzhen (CN)

(72) Inventors: Xianghui Ding, Shenzhen (CN); Deming Zhang, Shenzhen (CN); Zhiming Long, Shenzhen (CN)

(21) Appl. No.: 15/163,369

(22) Filed: May 24, 2016

Related U.S. Application Data
(63) Continuation of application No. PCT/CN2014/074631, filed on Apr. 2, 2014.

(30) Foreign Application Priority Data
Nov. 25, 2013 (CN) 201310608206.8

(51) Int. Cl. H04S 1/00

(52) U.S. Cl. CPC H04S 1/005

(57) ABSTRACT

A audio signal processing method includes: sampling and holding, in a time sharing manner, an audio-left channel analog signal output by an audio-left channel microphone of a stereo headset and an audio-right channel analog signal output by an audio-right channel microphone; performing analog-to-digital conversion on the audio-left channel analog signal and audio-right channel analog signal that are sampled and held, so as to obtain a corresponding audio-left channel digital signal and an audio-right channel digital signal; performing data encapsulation on the audio-left channel digital signal and the audio-right channel digital signal to obtain a serial digital signal; and receiving and demodulating, by a terminal, the serial digital signal to obtain an audio-left channel digital signal and an audio-right channel digital signal.

### CROSS-REFERENCE TO RELATED APPLICATIONS

This application is a continuation of International Application No. PCT/CN2014/074631, filed on Apr. 2, 2014, which claims priority to Chinese Patent Application No. 201310608206.8, filed on Nov. 25, 2013, both of which are hereby incorporated by reference in their entireties.

### TECHNICAL FIELD

The present disclosure relates to the field of stereo technologies, and in particular, to a stereo headset, a terminal, and audio signal processing methods thereof.

### BACKGROUND

A stereo sound collection device such as a dual-ear microphone stereo headset, as an important component of an audio device, is widely applied to terminals, such as various acoustic equipment, electronic play devices, and smartphones, because the stereo sound collection device can output a clear surround sound field and greatly improve audio experience of a user. Currently, a dual-ear microphone stereo headset includes an audio-left channel microphone, an audio-right channel microphone, an audio-left channel headset, and an audio-right channel headset and requires at least five wires including a ground wire during signal transmission, and accordingly, a headset plug also needs to be designed as a five-pin connector, which obviously cannot be compatible with a four-pin interface of a conventional monaural headset that is widely used in terminals such as smartphones.

In the prior art, compatibility between a dual-ear microphone stereo headset and a four-pin interface is implemented mainly in a manner of performing switching by using a mechanical switch. However, such a switching manner determines that a headset cannot use microphone and speaker (sound channel) functions simultaneously, that is, only one of sound channel analog signal collection and play functions can be selected. Therefore, in the prior art, compatibility between a dual-ear microphone stereo headset and a four-pin interface of a monaural headset of a terminal cannot be implemented favorably either.

### SUMMARY

In view of this, a technical problem mainly resolved by the present disclosure is to provide a stereo headset, a terminal, and audio signal processing methods thereof, which can implement compatibility between a stereo dual-ear microphone headset and a four-pin interface of a monaural headset of a terminal such as a smartphone.

According to a first aspect, an audio signal processing method of a stereo headset is provided, where the stereo headset includes a left-ear headset unit, a right-ear headset unit, and an external plug configured to connect to an external terminal, the external plug includes a microphone port, the left-ear headset unit includes an audio-left channel microphone and an audio-left channel headset, the right-ear headset unit includes an audio-right channel microphone and an audio-right channel headset, and the audio signal processing method includes: sampling and holding, in a time sharing manner, an audio-left channel analog signal output by the audio-left channel microphone and an audio-right channel analog signal output by the audio-right channel microphone; performing analog-to-digital conversion on the audio-left channel analog signal and audio-right channel analog signal that are sampled and held, so as to obtain a corresponding audio-left channel digital signal and a corresponding audio-right channel digital signal; performing data encapsulation on the audio-left channel digital signal and the audio-right channel digital signal to obtain a serial digital signal; and transmitting the serial digital signal to the external terminal by using the microphone port of the external plug.

With reference to an implementation manner of the first aspect, in a first possible implementation manner, the stereo headset further includes a mono microphone, and the step of transmitting the serial digital signal to the external terminal by using the microphone port of the external plug includes: detecting, by the stereo headset, a feeder voltage of the external terminal at the external plug; if a first feeder voltage is detected, transmitting the serial digital signal to the external terminal by using the microphone port of the external plug; and if a second feeder voltage is detected, transmitting a mono analog signal to the external terminal by using the microphone port of the external plug.

According to a second aspect, a stereo headset is provided, where the stereo headset includes a left-ear headset unit, a right-ear headset unit, and an external plug configured to connect to an external terminal, the external plug includes a microphone port, the left-ear headset unit includes an audio-left channel microphone and an audio-left channel headset, the right-ear headset unit includes an audio-right channel microphone and an audio-right channel headset, and the stereo headset further includes: a sampling and holding module, configured to sample and hold, in a time sharing manner, an audio-left channel analog signal and an audio-right channel analog signal that are respectively output by the audio-left channel microphone and the audio-right channel microphone; a first analog-to-digital conversion module, configured to perform analog-to-digital conversion on the audio-left channel analog signal and audio-right channel analog signal that are sampled and held by the sampling and holding module, so as to obtain a corresponding audio-left channel digital signal and a corresponding audio-right channel digital signal; and a signal encapsulation module, configured to perform data encapsulation on the audio-left channel digital signal and the audio-right channel digital signal to obtain a serial digital signal and transmit the serial digital signal to the external terminal by using the microphone port of the external plug.

With reference to an implementation manner of the second aspect, in a first possible implementation manner, the stereo headset further includes a mono microphone, a first selection module, and a feeder monitoring module, where the feeder monitoring module is configured to detect a feeder voltage of the external terminal at the external plug, and if a first feeder voltage is detected, the feeder monitoring module controls the first selection module to transmit the serial digital signal to the external terminal by using the microphone port of the external plug; and if a second feeder voltage is detected, the feeder monitoring module controls the first selection module to transmit a mono analog signal output by the mono microphone to the external terminal by using the microphone port of the external plug.

According to a third aspect, an audio signal processing method of a terminal is provided, where the terminal includes an external jack configured to connect to an external plug of a stereo headset, the external jack includes a microphone port, and the audio signal processing method includes: receiving, by using the microphone port of the external jack, an input signal transmitted by the stereo headset, where the input signal is a mono analog signal or a serial digital signal including an audio-left channel digital signal and an audio-right channel digital signal; and demodulating the input signal to obtain the audio-left channel digital signal and the audio-right channel digital signal that are included in the serial digital signal.

With reference to an implementation manner of the third aspect, in a first possible implementation manner, before the step of demodulating the input signal, the method further includes: identifying whether the input signal is the serial digital signal including the audio-left channel digital signal and the audio-right channel digital signal or the mono analog signal; if it is identified that the input signal is the serial digital signal, performing the step of demodulating the input signal; and if it is identified that the input signal is the mono analog signal, performing analog-to-digital conversion on the mono analog signal to obtain a mono digital signal.

With reference to the implementation manner of the third aspect, in a second possible implementation manner, the audio signal processing method further includes performing following steps while performing the step of demodulating the input signal: performing analog-to-digital conversion on the input signal to obtain a mono digital signal; and identifying whether the input signal is the serial digital signal including the audio-left channel digital signal and the audio-right channel digital signal or the mono analog signal; and after the step of identifying whether the input signal is the serial digital signal including the audio-left channel digital signal and the audio-right channel digital signal or the mono analog signal, the audio signal processing method further includes: if it is identified that the input signal is the serial digital signal, sending the audio-left channel digital signal and the audio-right channel digital signal to a next circuit of the terminal; and if it is identified that the input signal is the mono analog signal, sending the mono digital signal to the next circuit.

With reference to the implementation manner of the third aspect, in a third possible implementation manner, the audio signal processing method further includes: outputting a feeder voltage to the external plug to control the stereo headset to output the serial digital signal including the audio-left channel digital signal and the audio-right channel digital signal or the mono analog signal to a microphone port of the external plug.

With reference to the third possible implementation manner of the third aspect, in a fourth possible implementation manner, the step of outputting a feeder voltage to the external plug includes: if the stereo headset needs to output the serial digital signal, outputting a first feeder voltage to the external plug; and if the stereo headset needs to output the mono analog signal, outputting a second feeder voltage to the external plug.

With reference to the second possible implementation manner of the third aspect, in a fifth possible implementation manner, the audio signal processing method further includes: performing digital-to-analog conversion on the audio-left channel digital signal and the audio-right channel digital signal to obtain a corresponding audio-left channel analog signal and audio-right channel analog signal; and outputting the audio-left channel analog signal and the audio-right channel analog signal to an audio-left channel port and an audio-right channel port of the external plug by using the external jack.

With reference to the fifth possible implementation manner of the third aspect, in a sixth possible implementation manner, before the step of outputting the audio-left channel analog signal and the audio-right channel analog signal to an audio-left channel port and an audio-right channel port of the external plug by using the external jack, the method includes: performing adaptive noise cancellation, adaptive echo cancellation, and signal enhancement on the audio-left channel analog signal and the audio-right channel analog signal.

According to a fourth aspect, a terminal is provided, where the terminal includes an external jack configured to connect to an external plug of a stereo headset, the external jack includes a microphone port, and the terminal further includes: a receiving module, configured to receive, by using the microphone port of the external jack, an input signal transmitted by the stereo headset, where the input signal is a mono analog signal or a serial digital signal including an audio-left channel digital signal and an audio-right channel digital signal; and a demodulation module, configured to demodulate the input signal to obtain the audio-left channel digital signal and the audio-right channel digital signal that are included in the serial digital signal.

With reference to an implementation manner of the fourth aspect, in a first possible implementation manner, the terminal further includes an identification module and a second analog-to-digital conversion module, and the identification module is configured to identify whether the input signal received by the receiving module is the serial digital signal including the audio-left channel digital signal and the audio-right channel digital signal or the mono analog signal; if it is identified that the input signal is the serial digital signal, the demodulation module demodulates the input signal; and if it is identified that the input signal is the mono analog signal, the second analog-to-digital conversion module performs analog-to-digital conversion on the mono analog signal to obtain a mono digital signal.

With reference to the first possible implementation manner of the fourth aspect, in a second possible implementation manner, the terminal further includes a signal switching module, and when the identification module identifies that the input signal is the serial digital signal, the signal switching module is configured to control sending the audio-left channel digital signal and the audio-right channel digital signal that are obtained by the demodulation module to a next circuit of the terminal; and when the identification module identifies that the input signal is the mono analog signal, the signal switching module is configured to control sending the mono digital signal that is obtained by conversion performed by the second analog-to-digital conversion module to the next circuit.

With reference to the implementation manner of the fourth aspect, in a third possible implementation manner, the terminal further includes a feed output module, where the feed output module is configured to output a first feeder voltage to the external plug to control the stereo headset to output the serial digital signal including the audio-left channel digital signal and the audio-right channel digital signal to a microphone port of the external plug or output a second feeder voltage to the external plug to control the stereo headset to output the mono analog signal to the microphone port.

With reference to the third possible implementation manner of the fourth aspect, in a fourth possible implementation manner, the terminal further includes a digital-to-analog conversion module and a second selection module, where the digital-to-analog conversion module is configured to perform digital-to-analog conversion on the audio-left channel digital signal and the audio-right channel digital signal to obtain a corresponding audio-left channel analog signal and audio-right channel analog signal, and the second selection module is configured to output the audio-left channel analog signal and the audio-right channel analog signal to an audio-left channel port and an audio-right channel port of the external plug.

With reference to the fourth possible implementation manner of the fourth aspect, in a fifth possible implementation manner, the terminal further includes a speech signal processing module, and before the second selection module outputs the audio-left channel analog signal and the audio-right channel analog signal to the audio-left channel port and the audio-right channel port of the external plug, the speech signal processing module is configured to perform adaptive noise cancellation, adaptive echo cancellation, and signal enhancement on the audio-left channel analog signal and the audio-right channel analog signal.

According to a fifth aspect, an audio signal processing method of a stereo headset is provided, where the processing method is based on the stereo headset and a terminal adapted to the stereo headset, the stereo headset includes a left-ear headset unit, a right-ear headset unit, and an external plug configured to connect to an external terminal, the external plug includes a microphone port, the left-ear headset unit includes an audio-left channel microphone and an audio-left channel headset, the right-ear headset unit includes an audio-right channel microphone and an audio-right channel headset, the terminal includes an external jack configured to connect to the external plug of the stereo headset, the external jack includes a microphone interface, and the audio signal processing method includes: sampling and holding, in a time sharing manner, an audio-left channel analog signal output by the audio-left channel microphone and an audio-right channel analog signal output by the audio-right channel microphone; performing analog-to-digital conversion on the audio-left channel analog signal and audio-right channel analog signal that are sampled and held, so as to obtain a corresponding audio-left channel digital signal and a corresponding audio-right channel digital signal; performing data encapsulation on the audio-left channel digital signal and the audio-right channel digital signal to obtain a serial digital signal; transmitting the serial digital signal to the terminal by using the microphone port of the external plug; receiving, by the terminal by using a microphone port of the external jack, an input signal transmitted by the stereo headset, where the input signal is a mono analog signal or a serial digital signal including an audio-left channel digital signal and an audio-right channel digital signal; and demodulating, by the terminal, the input signal to obtain the audio-left channel digital signal and the audio-right channel digital signal that are included in the serial digital signal.

With reference to an implementation manner of the fifth aspect, in a first possible implementation manner, the stereo headset further includes a mono microphone, and the step of transmitting the serial digital signal to the external terminal by using the microphone port of the external plug includes: detecting, by the stereo headset, a feeder voltage of the external terminal at the external plug; if a first feeder voltage is detected, transmitting the serial digital signal to the external terminal by using the microphone port of the external plug; and if a second feeder voltage is detected, transmitting a mono analog signal to the external terminal by using the microphone port of the external plug.

With reference to the implementation manner of the fifth aspect, in a second possible implementation manner, before the step of demodulating the input signal, the method further includes: identifying whether the input signal is the serial digital signal including the audio-left channel digital signal and the audio-right channel digital signal or the mono analog signal; if it is identified that the input signal is the serial digital signal, performing the step of demodulating the input signal; and if it is identified that the input signal is the mono analog signal, performing analog-to-digital conversion on the mono analog signal to obtain a mono digital signal.

A beneficial effect of the present disclosure is that different from a situation of the prior art, in the present disclosure, digital encapsulation is performed on an audio-left channel digital signal and an audio-right channel digital signal corresponding to an audio-left channel microphone and an audio-right channel microphone to obtain a serial digital signal that can be transmitted on one wire, thereby transmitting signals of two microphones, namely, left and right microphones, on a microphone unit of a four-pin external plug of a headset, and implementing compatibility between a dual-ear microphone stereo headset and a conventional monaural headset in a four-pin interface.

### BRIEF DESCRIPTION OF THE DRAWINGS

To describe the technical solutions of the present disclosure more clearly, in the following the accompanying drawings are briefly introduced describing embodiments of the present disclosure. Apparently, the accompanying drawings in the following description show merely some embodiments of the present disclosure.

FIG. 1 is a flowchart of an audio signal processing method of a first embodiment of the present disclosure;

FIG. 2 is a schematic structural diagram of an exemplary embodiment of a stereo headset and a terminal of the present disclosure;

FIG. 3 is a flowchart of an audio signal processing method of a second embodiment of the present disclosure;

FIG. 4 is a principle block diagram of an audio signal processing system of the first embodiment of the present disclosure;

FIG. 5 is a principle block diagram of an audio signal processing system of the second embodiment of the present disclosure;

FIG. 6 is a principle block diagram of an audio signal processing system of a third embodiment of the present disclosure; and

FIG. 7 is a principle block diagram of an audio signal processing system of a fourth embodiment of the present disclosure.

### DETAILED DESCRIPTION

The following clearly describes the technical solutions of the present disclosure with reference to the accompanying drawings showing embodiments of the present disclosure. Apparently, the described embodiments are merely some but not all of the embodiments of the present disclosure.

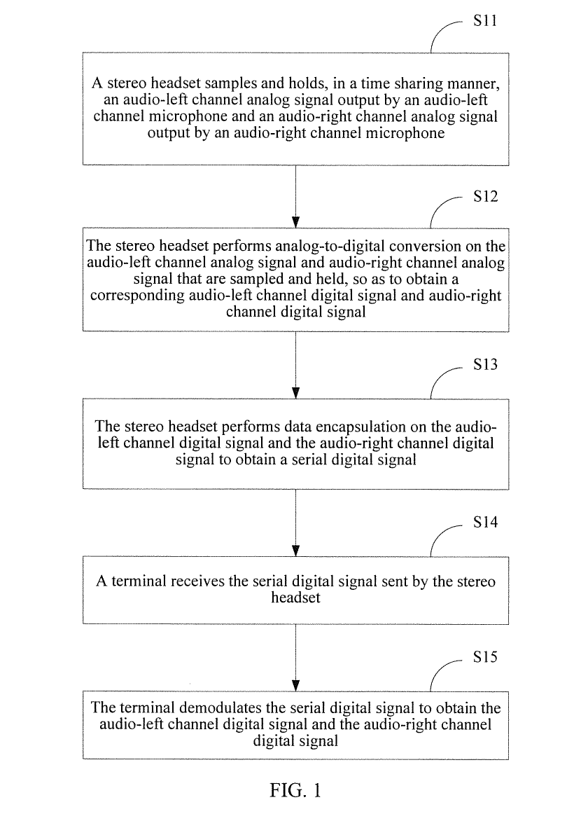

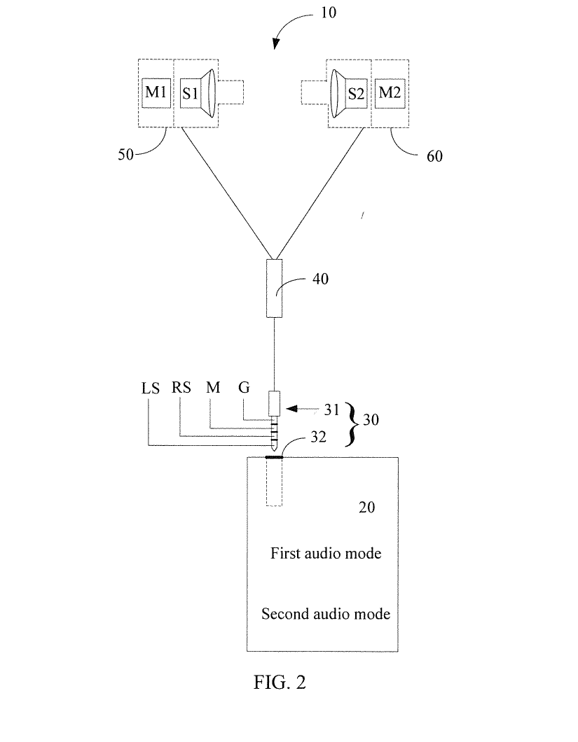

The present disclosure provides an audio signal processing method. Refer to a flowchart of an audio signal processing method of a first embodiment of the present disclosure in FIG. 1. The audio signal processing method of this embodiment is based on a stereo headset 10 and a terminal (an external terminal) 20 that are shown in FIG. 2, between which an electrical connection is implemented by using a four-segment-type pin structure 30, where the four-segment-type pin structure 30 includes an external plug 31 disposed on a side of the stereo headset 10 and an external jack 32 disposed on a side of the terminal 20.

In this embodiment, a dual-ear microphone stereo headset is preferably selected as the stereo headset 10, and in addition to the external plug 31 configured to connect to the terminal 20, the stereo headset 10 further includes a left-ear headset unit 50 and a right-ear headset unit 60, where the left-ear headset unit 50 includes an audio-left channel microphone M1 and an audio-left channel headset (a left speaker) S1, and the right-ear headset unit 60 includes an audio-right channel microphone M2 and an audio-right channel headset (a right speaker) S2. The audio-left channel microphone M1 and the audio-right channel microphone M2 are favorably acoustically isolated from the audio-left channel headset S1 and the audio-right channel headset S2 respectively, and M1 and M2 are independently disposed on the left and right mainly for collecting a corresponding audio-left channel analog signal and audio-right channel analog signal. In addition, the external plug 31 of the four-segment-type pin structure 30 includes a ground port G, a microphone port M connected to the audio-left channel microphone M1 and the audio-right channel microphone M2, and an audio-left channel port LS and an audio-right channel port RS respectively connected to the audio-left channel headset S1 and the audio-right channel headset S2, and the external jack 32 includes structures adapted to ports of the foregoing external plug 31, for example, includes a microphone interface adapted to the microphone port M.

It should be noted that a position sequence of the ground port G, the microphone port M, the audio-left channel port LS, and the audio-right channel port RS of the external plug 31 shown in FIG. 2 is merely provided as an example for description, and a person skilled in the art can perform another disposition according to an actual requirement in another embodiment.

In the present disclosure, the stereo headset 10 mentioned in the entire following text is described by using a dual-ear microphone stereo headset as an example, and certainly, the stereo headset 10 is not limited thereto and may be any multi-channel headset having an audio-left channel microphone M1 and an audio-right channel microphone M2. In addition, the terminal 20 is described by using a smartphone as an example, is not limited to the smartphone either, and may be any terminal having a four-segment-type pin structure 30, such as a tablet computer, a personal digital assistant (PDA), or a portable communications apparatus.

As shown in FIG. 1, the audio signal processing method of this embodiment includes:

Step S11: A stereo headset samples and holds, in a time sharing manner, an audio-left channel analog signal output by an audio-left channel microphone and an audio-right channel analog signal output by an audio-right channel microphone.

Referring to FIG. 2, the audio-left channel microphone M1 and the audio-right channel microphone M2 separately collect information about a sound in a surrounding sound field in real time and respectively output the sound as an audio-left channel analog signal and an audio-right channel analog signal.

Because analog-to-digital conversion requires a period of time, and sample values of the audio-left channel analog signal and the audio-right channel analog signal continuously change within this period of time, it is necessary to ensure that the sample values of the audio-left channel analog signal and the audio-right channel analog signal during each instantaneous sampling keep unchanged during the analog-to-digital conversion, so that accuracy of the analog-to-digital conversion can be ensured. It should be noted that in the present disclosure, the audio-left channel analog signal and the audio-right channel analog signal that are output are specifically presented as voltage values, and corresponding sample values are sample voltage values.

Step S12: The stereo headset performs analog-to-digital conversion on the audio-left channel analog signal and audio-right channel analog signal that are sampled and held, so as to obtain a corresponding audio-left channel digital signal and a corresponding audio-right channel digital signal.

Step S13: The stereo headset performs data encapsulation on the audio-left channel digital signal and the audio-right channel digital signal to obtain a serial digital signal.

A major objective of the present disclosure is transmitting an audio-left channel microphone signal and an audio-right channel microphone signal on one wire (the microphone port M of the external plug 31). Therefore, it is first necessary to digitize analog signals of an audio-left channel and an audio-right channel, and then a serial digital signal that can be transmitted on the wire is obtained in a digital encapsulation manner.

When the analog-to-digital conversion is performed in step S12, a Σ-Δ-type digital-to-analog converter, a pipeline-type digital-to-analog converter, or the like that outputs a 1-bit, 4-bit, or 16-bit digital signal may be used. In step S13, the serial digital signal may be obtained in a data encapsulation manner such as AES3. Moreover, in this embodiment, the serial digital signal preferably obtained by means of encapsulation includes a packet header, an actual load, and a check bit in sequence.

The packet header includes synchronization information and clock information and is used to ensure synchronization between the audio-left channel digital signal and the audio-right channel digital signal that are received by the terminal 20 and the audio-left channel digital signal and the audio-right channel digital signal that are output by the stereo headset 10 in terms of a transmission sequence and identify a starting time and an ending time for transmission of the audio-left channel digital signal and the audio-right channel digital signal.

The actual load includes the audio-left channel digital signal and the audio-right channel digital signal that need to be transmitted.

The check bit includes a check code and is mainly used by the terminal 20 to verify validity and integrity of the received serial digital signal, so as to ensure that the audio-left channel digital signal and the audio-right channel digital signal received by the terminal 20 are not damaged or lost.

It should be understood that a structure included in the foregoing serial digital signal and a position sequence of the packet header, the actual load, and the check bit are merely provided as examples for description, and in the present disclosure, another data encapsulation manner may be used according to a specific data encapsulation requirement and the present disclosure is not limited to the AES3 encapsulation manner exemplified in the preceding text. In addition, it should be noted that in this embodiment, the type of the used analog-to-digital converter and a quantity of bits of the output digital signal may be specifically determined according to the data encapsulation manner in step S13.

In addition, steps S12 and S13 of this embodiment are preferably performed under the control of a drive-by-wire module 40 disposed on a headset wire shown in FIG. 2. Further, a voltage required by the analog-to-digital converter for working comes from a feed supplied by the terminal 20 to the headset wire by using the external jack 32. Based on this, in this embodiment, more power support may be provided for another device, such as the analog-to-digital converter, on the headset wire by increasing a voltage value of the feed.

Step S14: A terminal receives the serial digital signal sent by the stereo headset.

The stereo headset 10 transmits the serial digital signal obtained in step S13 to the terminal 20 by using the microphone port M of the external plug 31.

Step S15: The terminal demodulates the serial digital signal to obtain the audio-left channel digital signal and the audio-right channel digital signal.

When detecting an input signal transmitted by the stereo headset 10, the terminal 20 first identifies whether the input signal has an identification packet header of the serial digital signal. If it is identified that the input signal has the packet header, it is determined that the input signal is the serial digital signal obtained after the data encapsulation in step S13 and then, the demodulation in step S15 is performed. If it is identified that the input signal has no packet header, the input signal is not demodulated.

Based on the above, it can be known that in this embodiment, a serial digital signal that can be transmitted on one wire is obtained mainly by performing analog-to-digital conversion on an audio-left channel analog signal and an audio-right channel analog signal collected by the audio-left channel microphone M1 and the audio-right channel microphone M2 of the stereo headset 10 to perform digital encapsulation on an audio-left channel digital signal and an audio-right channel digital signal that are obtained, so as to implement transmitting sound channel analog signals of two microphones, namely, the left and right microphones, on the microphone port M of the external plug 31, so that the dual-ear microphone stereo headset can be connected to the terminal 20 by using a conventional four-pin external plug.

The present disclosure further provides an audio signal processing method of a second embodiment, which is described in detail on the basis of the audio signal processing method disclosed in the first embodiment. This embodiment differs from the audio signal processing method of the first embodiment in that:

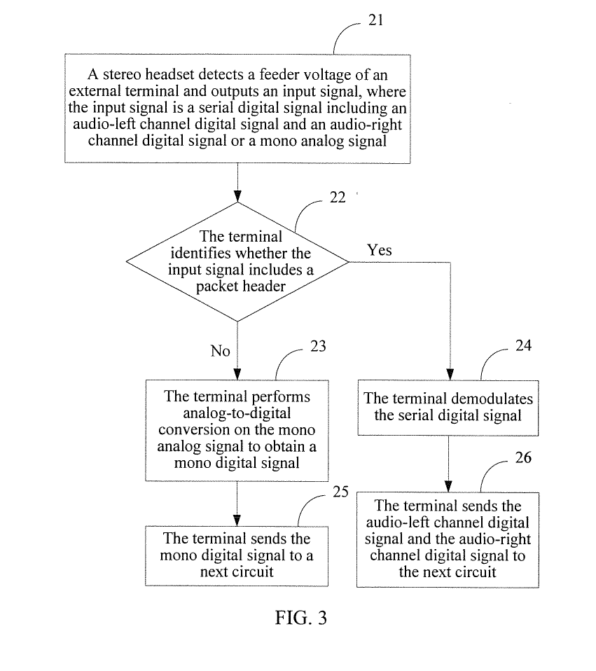

In this embodiment, a mono microphone (which can be disposed in the drive-by-wire module 40 shown in FIG. 2) is further disposed on the headset wire of the stereo headset, and is equivalent to a microphone on the current headset wire, so that a headset jack of the terminal 20 is compatible with a conventional mono (microphone) stereo headset. As shown in FIG. 3, the audio signal processing method of this embodiment includes following steps:

Step S21: The stereo headset detects a feeder voltage of the external terminal and outputs an input signal, where the input signal is a serial digital signal including an audio-left channel digital signal and an audio-right channel digital signal or a mono analog signal.

When a user chooses to use a mono microphone, the audio-left channel microphone M1 and the audio-right channel microphone M2 shown in FIG. 2 stop collecting and outputting an audio-left channel analog signal and an audio-right channel analog signal.

In this embodiment, preferably, the user performs the foregoing choice by using a touchscreen of the terminal 20, and during actual operation, a first audio mode and a second audio mode may be provided in the terminal 20. Specifically, when the user selects the first audio mode, the stereo headset 10 needs to respectively collect and output an audio-left channel analog signal and an audio-right channel analog signal by using the audio-left channel microphone M1 and the audio-right channel microphone M2; and when the user selects the second audio mode, the stereo headset 10 needs to collect and output a mono analog signal by using the mono microphone.

When the user selects the first audio mode or the second audio mode, the terminal 20 outputs a feeder voltage to the external plug 31 to make the drive-by-wire module 40 control, according to the feeder voltage, the stereo headset 10 to output a serial digital signal including an audio-left channel digital signal and an audio-right channel digital signal or a mono analog signal to the microphone port M. Specifically,

when the user selects the first audio mode, it indicates that the stereo headset 10 needs to output a serial digital signal, and in this case, the terminal 20 outputs a first feeder voltage to the external plug 31. When the user selects the second audio mode, it indicates that the stereo headset 10 needs to output a mono analog signal, and in this case, the terminal 20 outputs a second feeder voltage to the external plug 31.

The stereo headset 10 detects a feeder voltage of the external plug 31 in real time or in a time sharing manner, and if the first feeder voltage is detected, the serial digital signal is transmitted to the terminal 20 by using the microphone port M of the external plug 31. If the second feeder voltage is detected, the mono analog signal is transmitted to the terminal 20 by using the microphone port M of the external plug 31.

It should be noted that in this embodiment, the stereo headset 10 is controlled mainly by detecting a feeder voltage to output a serial digital signal including an audio-left channel digital signal and an audio-right channel digital signal or a mono analog signal to the microphone port M, and in another embodiment, a person skilled in the art can select another circuit measure, such as impedance or current, according to an actual requirement.

Step S22: The terminal receives the input signal and identifies whether the input signal includes a packet header.

After receiving the input signal output by the stereo headset 10, the terminal 20 determines whether the input signal is the serial digital signal including the audio-left channel digital signal and the audio-right channel digital signal or the mono analog signal by identifying whether the input signal includes a packet header obtained after data encapsulation.

If the terminal identifies that the input signal does not include a packet header, that is, the input signal is the mono analog signal, step S23 is performed to obtain a mono digital signal. If the terminal 20 identifies that the input signal includes a packet header, that is, the input signal is the serial digital signal, step S24 is performed to demodulate the serial digital signal.

Step S23: The terminal performs analog-to-digital conversion on the mono analog signal to obtain a mono digital signal.

Step S24: The terminal demodulates the serial digital signal.

It should be noted that step S23 and step S24 of this embodiment are not correlated and may be considered as two steps that are performed at the same time or selectively after step S22, that is, only one of the two steps is performed under the control of one selection instruction of the user; if the user selects the first audio mode, only step S24 is performed, and step S23 is not performed; if the user selects the second audio mode, only step S23 is performed, and step S24 is not performed.

Step S25: If the terminal identifies that the input signal is the mono analog signal, send the mono digital signal obtained by means of the analog-to-digital conversion to a next circuit of the terminal.

Step S26: If the terminal identifies that the input signal is the serial digital signal, the terminal sends the audio-left channel digital signal and the audio-right channel digital signal obtained by means of the demodulation to the next circuit.

After the serial digital signal is sent to the next circuit, the terminal 20 may make a stereo voice call. Specifically,

referring to FIG. 2 again, the audio-left channel microphone M1 and the audio-right channel microphone M2 of the stereo headset 10 are respectively worn on the left ear and the right ear of a calling party. The audio-left channel microphone M1 collects an audio-left channel analog signal of a speech signal of the calling party, the audio-right channel microphone M2 collects an audio-right channel analog signal of the speech signal of the calling party, the stereo headset 10 sends the audio-left channel analog signal and the audio-right channel analog signal to the terminal 20 by using the four-segment-type pin structure 30 by means of the audio signal processing method of the first embodiment, the next circuit of the terminal 20 transmits the audio-left channel analog signal and the audio-right channel analog signal to a called party by using a network, and the audio-left channel analog signal and the audio-right channel analog signal are played by using an audio-left channel headset and an audio-right channel headset of the called party, so that the called party obtains stereo call experience.

During a voice call, because the audio-left channel microphone M1 and audio-right channel microphone M2 cannot be completely acoustically isolated from an audio-left channel headset LS and an audio-right channel headset RS, it is necessary to perform adaptive echo cancellation processing (Adaptive Echo Cancellation, AEC) on an audio-left channel analog signal and an audio-right channel analog signal that are collected by the audio-left channel microphone M1 and audio-right channel microphone M2, so as to cancel sounds that are made by the audio-left channel headset LS and audio-right channel headset RS and that are respectively collected by the audio-left channel microphone M1 and audio-right channel microphone M2.

In addition, because during a call, a sound production source (the mouth) of the user (the calling party) has a considerable distance from the audio-left channel microphone M1 and audio-right channel microphone M2, and there is background noise in a call environment, it is further necessary to perform adaptive noise cancellation (Adaptive Noise Cancellation, ANC) on the audio-left channel analog signal and audio-right channel analog signal that are collected by the audio-left channel microphone M1 and audio-right channel microphone M2, and on the side of the called party, a terminal needs to perform signal enhancement processing on the audio-left channel analog signal and audio-right channel analog signal that are output to an audio-left channel headset and an audio-right channel headset.

Certainly, after the serial digital signal is sent to the next circuit, the terminal 20 may further perform dual-ear stereo recording, that is, the audio-left channel microphone M1 and the audio-right channel microphone M2 transmit, by using the four-segment-type pin structure 30, the audio-left channel analog signal and audio-right channel analog signal that are collected respectively to the terminal 20, and the terminal 20 stores the audio-left channel analog signal and audio-right channel analog signal in a form of an audio-left channel digital signal and an audio-right channel digital signal in a memory. The terminal 20 may further perform dual-ear stereo monitoring (also equivalent to a hearing aid), that is, after processing, such as digital-to-analog conversion, low-latency processing, gain processing, and acoustic echo suppression processing (Acoustic Echo Suppression, AES), is performed on the stored audio-left channel digital signal and audio-right channel digital signal, stereo playing is performed by using an audio-left channel port LS and an audio-right channel port RS. It should be understood that the audio-left channel port LS and audio-right channel port RS are merely a specific example and are merely used to vividly and directly describe output of an audio-left channel analog signal and output of an audio-right channel analog signal.

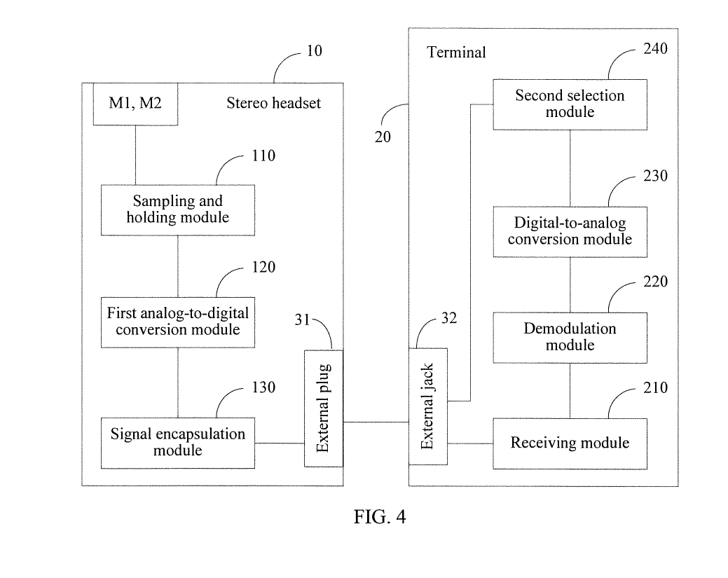

The present disclosure further provides an audio signal processing system, including the stereo headset 10, the terminal 20, and the four-segment-type pin structure 30 that are shown in FIG. 2. As shown in FIG. 4, on the basis of the illustration of FIG. 2, the stereo headset 10 of this embodiment further includes a sampling and holding module 110, a first analog-to-digital conversion module 120, and a signal encapsulation module 130, and the terminal 20 includes a receiving module 210, a demodulation module 220, a digital-to-analog conversion module 230, and a second selection module 240.

In this embodiment, the sampling and holding module 110 is configured to sample and hold, in a time sharing manner, an audio-left channel analog signal and an audio-right channel analog signal that are respectively output by the audio-left channel microphone M1 and the audio-right channel microphone M2.

The first analog-to-digital conversion module 120 is configured to perform analog-to-digital conversion on the audio-left channel analog signal and audio-right channel analog signal that are sampled and held by the sampling and holding module 110, so as to obtain a corresponding audio-left channel digital signal and a corresponding audio-right channel digital signal.

The signal encapsulation module 130 is configured to perform data encapsulation on the audio-left channel digital signal and the audio-right channel digital signal to obtain a serial digital signal. The serial digital signal is transmitted to the receiving module 210 by using the external plug 31 and the external jack 32.

The demodulation module 220 is configured to demodulate the serial digital signal received by the receiving module 210, so as to obtain the audio-left channel digital signal and the audio-right channel digital signal.

The digital-to-analog conversion module 230 is configured to perform digital-to-analog conversion on the audio-left channel digital signal and the audio-right channel digital signal to obtain a corresponding audio-left channel analog signal and audio-right channel analog signal.

The second selection module 240 is configured to output, by using the external jack 32, the audio-left channel analog signal and the audio-right channel analog signal to the external plug 31 and then to the audio-left channel port LS and audio-right channel port RS of the external plug 31 shown in FIG. 2. It should be understood that the audio-left channel port LS and audio-right channel port RS are merely a specific example and are merely used to vividly and directly describe output of an audio-left channel analog signal and output of an audio-right channel analog signal.

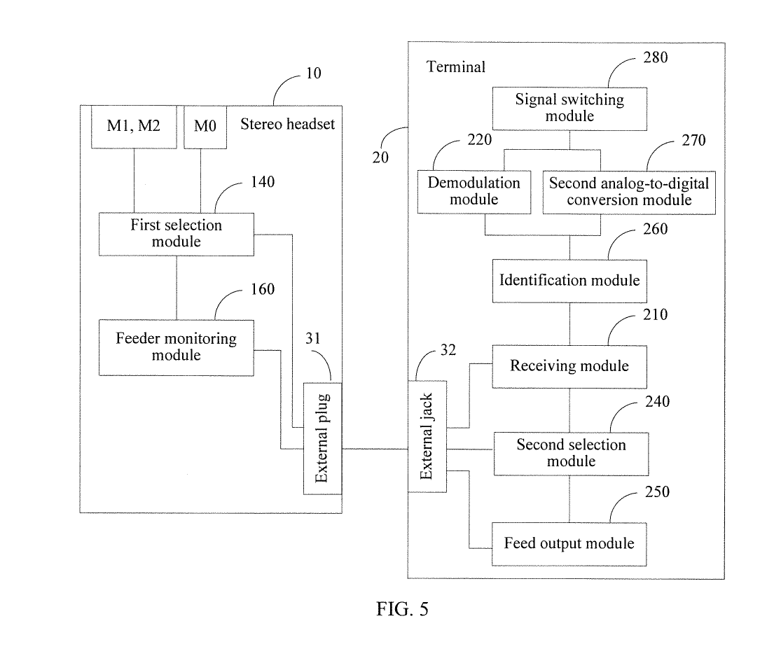

The present disclosure further provides an audio signal processing system of the second embodiment, which is described in detail on the basis of the audio signal processing system of the first embodiment. As shown in FIG. 5, this embodiment differs from the first embodiment in that:

In this embodiment, the stereo headset 10 further includes a mono microphone M0, a first selection module 140, and a feeder monitoring module 160, and the terminal 20 further includes a feed output module 250, an identification module 260, a second analog-to-digital conversion module 270, and a signal switching module 280.

The feeder monitoring module 160 is configured to detect a feeder voltage of the external terminal 20 at the external plug 21.

The first selection module 140 is configured to choose, according to a selection instruction, to transmit one of the mono analog signal output by the mono microphone M0 and the serial digital signal to the terminal 20 by using the microphone port M (see FIG. 2) of the external plug 31 and the external jack 32.

In this embodiment, the selection instruction of the user is preferably a feeder voltage in a specific implementation process. Specifically,

if the user needs to output a serial digital signal, the second selection module 240 controls the feed output module 250 to be configured to output a first feeder voltage to the external plug 31. If the feeder monitoring module 160 detects the first feeder voltage at the external plug 31, the first selection module 140 transmits the serial digital signal to the receiving module 210 of the terminal 20 by using the microphone port M of the external plug 31. The identification module 260 is configured to identify that the input signal received by the receiving module 210 is a serial digital signal, the demodulation module 220 is configured to demodulate the input signal (the serial digital signal), and the signal switching module 280 is configured to control sending an audio-left channel digital signal and an audio-right channel digital signal that are obtained by the demodulation module 220 to a next circuit of the terminal 20.

If the user needs to output a mono analog signal, the second selection module 240 controls the feed output module 250 to be configured to output a second feeder voltage to the external plug 31. If the feeder monitoring module 160 detects the second feeder voltage at the external plug 31, the first selection module 140 controls the stereo headset 10 to transmit the mono analog signal to the receiving module 210 of the terminal 20 by using the microphone port M of the external plug 31. The identification module 260 is configured to identify that the input signal received by the receiving module 210 is a mono analog signal, the second analog-to-digital conversion module 270 performs analog-to-digital conversion on the mono analog signal, and the signal switching module 280 is configured to control sending a mono digital signal obtained by conversion performed by the second analog-to-digital conversion module 270 to the next circuit.

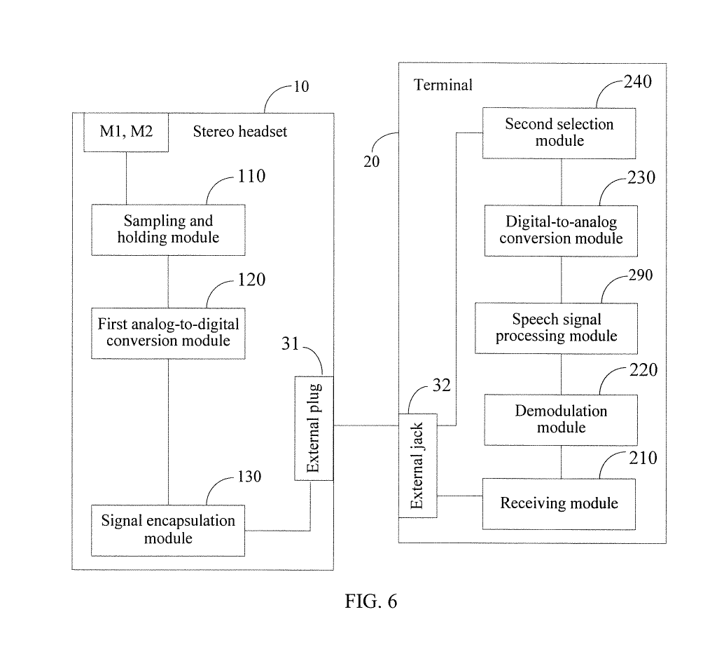

The present disclosure further provides an audio signal processing system of a third embodiment, which is described in detail on the basis of the audio signal processing system of the first embodiment. As shown in FIG. 6, this embodiment differs from the first embodiment in that:

In this embodiment, the terminal 20 further includes a speech signal processing module 290.

Before the second selection module 240 outputs an audio-left channel analog signal and an audio-right channel analog signal to the audio-left channel port LS and the audio-right channel port RS of the external plug 31, the speech signal processing module 290 is configured to perform adaptive noise cancellation, adaptive echo cancellation, and signal enhancement on the audio-left channel analog signal and the audio-right channel analog signal.

In the present disclosure, the audio signal processing systems, the stereo headset 10, and the terminal 20 of the foregoing several embodiments are correspondingly based on the audio signal processing methods of the foregoing embodiments, and therefore, may have the same technical effects with those of the audio signal processing methods. In addition, it should be understood that the division of described modules of the disclosed stereo headset 10 and terminal 20 is merely logical function division and may be another division in actual implementation. For example, multiple modules may be combined or integrated into another system, or some features may be ignored or not performed. In addition, a coupling or communication connection between modules may be implemented by using some interfaces or may be electrical or in another form.

The foregoing functional modules, as constituent parts of the stereo headset 10 and the terminal 20, may be or may not be physical blocks, not only can be located at one place, but also can be distributed on multiple network units, and not only can be implemented in a form of hardware, but also can be implemented in a form of a software functional block. Some or all of the modules may be selected according to actual requirements to achieve the objectives of the solutions of the present disclosure.

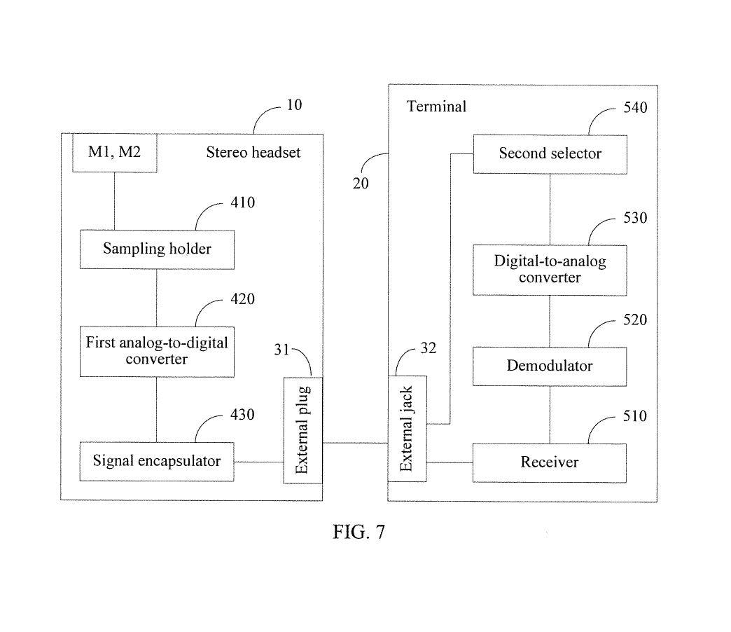

The present disclosure further provides an audio signal processing system of a fourth embodiment, including the stereo headset 10, the terminal 20, and the four-segment-type pin structure 30 that are shown in FIG. 2. As shown in FIG. 7, on the basis of the illustration of FIG. 2, the stereo headset 10 of this embodiment includes a sampling holder 410, a first analog-to-digital converter 420, and a signal encapsulator 430, and the terminal 20 includes a receiver 510, a demodulator 520, a digital-to-analog converter 530, and a second selector 540.

In this embodiment, the sampling holder 410 is configured to sample and hold, in a time sharing manner, an audio-left channel analog signal and an audio-right channel analog signal that are respectively output by the audio-left channel microphone M1 and the audio-right channel microphone M2.

The first analog-to-digital converter 420 is configured to perform analog-to-digital conversion on the audio-left channel analog signal and audio-right channel analog signal that are sampled and held by the sampling holder 410, so as to obtain a corresponding audio-left channel digital signal and a corresponding audio-right channel digital signal.

The signal encapsulator 430 is configured to perform data encapsulation on the audio-left channel digital signal and the audio-right channel digital signal to obtain a serial digital signal.

The demodulator 520 is configured to demodulate the serial digital signal received by the receiver 510, so as to obtain the audio-left channel digital signal and the audio-right channel digital signal.

The digital-to-analog converter 530 is configured to perform digital-to-analog conversion on the audio-left channel digital signal and the audio-right channel digital signal to obtain a corresponding audio-left channel analog signal and audio-right channel analog signal.

The second selector 540 is configured to output, by using the external jack 32, the audio-left channel analog signal and the audio-right channel analog signal to the external plug 31 and then to the audio-left channel port LS and audio-right channel port RS of the external plug 31 shown in FIG. 2.

In conclusion, in the present disclosure, digital encapsulation is performed on an audio-left channel digital signal and an audio-right channel digital signal corresponding to an audio-left channel microphone and an audio-right channel microphone to obtain a serial digital signal that can be transmitted on one wire, thereby transmitting signals of two microphones, namely, left and right microphones, on one wire, and implementing compatibility between a stereo dual-ear microphone headset and a conventional monaural headset in a four-pin interface.

The foregoing descriptions are merely embodiments of the present disclosure, and the protection scope of the present disclosure is not limited thereto.

What is claimed is:

1. An audio signal processing method of a stereo headset, wherein the stereo headset comprises a left-ear headset unit, a right-ear headset unit, and an external plug configured to connect to an external terminal, the external plug comprises a microphone port, the left-ear headset unit comprises an audio-left channel microphone and an audio-left channel headset, the right-ear headset unit comprises an audio-right channel microphone and an audio-right channel headset, and the method comprises:
sampling and holding, in a time sharing manner, an audio-left channel analog signal output by the audio-left channel microphone and an audio-right channel analog signal output by the audio-right channel microphone;
performing analog-to-digital conversion on the audio-left channel analog signal and audio-right channel analog signal that are sampled and held, so as to obtain a corresponding audio-left channel digital signal and a corresponding audio-right channel digital signal;
performing data encapsulation on the audio-left channel digital signal and the audio-right channel digital signal to obtain a serial digital signal; and
transmitting the serial digital signal to the external terminal by using the microphone port of the external plug.

2. The audio signal processing method according to claim 1, wherein:
the stereo headset further comprises a mono microphone; and
transmitting the serial digital signal to the external terminal by using the microphone port of the external plug comprises:
detecting, by the stereo headset, a feeder voltage of the external terminal at the external plug,
transmitting the serial digital signal to the external terminal by using the microphone port of the external plug when a first feeder voltage is detected, and
transmitting a mono analog signal output by the mono microphone to the external terminal by using the microphone port of the external plug when a second feeder voltage is detected.

3. A stereo headset, comprising:
a left-ear headset unit, a right-ear headset unit, and an external plug configured to connect to an external terminal, the external plug comprises a microphone port, the left-ear headset unit comprises an audio-left channel microphone and an audio-left channel headset, the right-ear headset unit comprises an audio-right channel microphone and an audio-right channel headset; a sampling and holding module, configured to sample and hold, in a time sharing manner, an audio-left channel analog signal output by the audio-left channel microphone and an audio-right channel analog signal output by the audio-right channel microphone;
a first analog-to-digital conversion module, configured to perform analog-to-digital conversion on the audio-left channel analog signal and audio-right channel analog signal that are sampled and held by the sampling and holding module, so as to obtain a corresponding audio-left channel digital signal and a corresponding audio-right channel digital signal; and
a signal encapsulation module, configured to perform data encapsulation on the audio-left channel digital signal and the audio-right channel digital signal to obtain a serial digital signal and transmit the serial digital signal to the external terminal by using the microphone port of the external plug.

4. The stereo headset according to claim 3, further comprising:
a mono microphone;
a first selection module; and
a feeder monitoring module configured to:
detect a feeder voltage of the external terminal at the external plug,
control the first selection module to transmit the serial digital signal to the external terminal by using the microphone port of the external plug when a first feeder voltage is detected, and
control the first selection module to transmit a mono analog signal output by the mono microphone to the external terminal by using the microphone port of the external plug when a second feeder voltage is detected.

5. An audio signal processing method of a terminal, wherein the terminal comprises an external jack configured to connect to an external plug of a stereo headset, the external jack comprises a microphone interface, and the audio signal processing method comprises:
receiving, by using a microphone interface of the external jack, an input signal transmitted by the stereo headset, wherein the input signal is a mono analog signal or a serial digital signal comprising an audio-left channel digital signal and an audio-right channel digital signal; and
demodulating the input signal to obtain the audio-left channel digital signal and the audio-right channel digital signal that are comprised in the serial digital signal.

6. The audio signal processing method according to claim 5, wherein before demodulating the input signal, the method comprises:
identifying whether the input signal is the serial digital signal comprising the audio-left channel digital signal and the audio-right channel digital signal or the mono analog signal;
demodulating the input signal when it is identified that the input signal is the serial digital signal; and
performing analog-to-digital conversion on the mono analog signal to obtain a mono digital signal when it is identified that the input signal is the mono analog signal.

7. The audio signal processing method according to claim 5, wherein the audio signal processing method further comprises performing following steps while performing the step of demodulating the input signal:
performing analog-to-digital conversion on the input signal to obtain a mono digital signal; and
identifying whether the input signal is the serial digital signal comprising the audio-left channel digital signal and the audio-right channel digital signal or the mono analog signal; and
after identifying whether the input signal is the serial digital signal comprising the audio-left channel digital signal and the audio-right channel digital signal or the mono analog signal, the audio signal processing method further comprises:
sending the audio-left channel digital signal and the audio-right channel digital signal to a next circuit of the terminal when it is identified that the input signal is the serial digital signal, and
sending the mono digital signal to the next circuit when it is identified that the input signal is the mono analog signal.

8. The audio signal processing method according to claim 5, further comprising:
outputting a feeder voltage to the external plug to control the stereo headset to output the serial digital signal comprising the audio-left channel digital signal and the audio-right channel digital signal or the mono analog signal to a microphone port of the external plug.

9. The audio signal processing method according to claim 8, wherein outputting a feeder voltage to the external plug comprises:
outputting a first feeder voltage to the external plug when the stereo headset needs to output the serial digital signal; and
outputting a second feeder voltage to the external plug when the stereo headset needs to output the mono analog signal.

10. The audio signal processing method according to claim 7, further comprising:
performing digital-to-analog conversion on the audio-left channel digital signal and the audio-right channel digital signal to obtain a corresponding audio-left channel analog signal and audio-right channel analog signal; and
outputting the audio-left channel analog signal and the audio-right channel analog signal to an audio-left channel port and an audio-right channel port of the external plug by using the external jack.

11. The audio signal processing method according to claim 10, wherein before outputting the audio-left channel analog signal and the audio-right channel analog signal to an audio-left channel port and an audio-right channel port of the external plug by using the external jack, the method comprises:
performing adaptive noise cancellation, adaptive echo cancellation, and signal enhancement on the audio-left channel analog signal and the audio-right channel analog signal.

12. A terminal, comprising:
an external jack configured to connect to an external plug of a stereo headset and comprising a microphone interface;
a receiving module, configured to receive, by using the microphone interface of the external jack, an input signal transmitted by the stereo headset, wherein the input signal is a mono analog signal or a serial digital signal comprising an audio-left channel digital signal and an audio-right channel digital signal; and
a demodulation module, configured to demodulate the input signal to obtain the audio-left channel digital signal and the audio-right channel digital signal that are comprised in the serial digital signal.

13. The terminal according to claim 12, further comprising:
an identification module configured to identify whether the input signal received by the receiving module is the serial digital signal comprising the audio-left channel digital signal and the audio-right channel digital signal or the mono analog signal, wherein the demodulation module is configured to demodulate the input signal when the identification module identified that the input signal is the serial digital signal; and
a second analog-to-digital conversion module configured to perform analog-to-digital conversion on the mono analog signal to obtain a mono digital signal when the identification module identified that the input signal is the mono analog signal.

14. The terminal according to claim 13, further comprising:
a signal switching module configured to:
control sending the audio-left channel digital signal and the audio-right channel digital signal that are obtained by the demodulation module to a next circuit of the terminal when the identification module identifies that the input signal is the serial digital signal; and
control sending the mono digital signal that is obtained by conversion performed by the second analog-to-digital conversion module to the next circuit when the identification module identifies that the input signal is the mono analog signal.

15. The terminal according to claim 12, further comprising:
a feed output module configured to:
output a first feeder voltage to the external plug to control the stereo headset to output the serial digital signal comprising the audio-left channel digital signal and the audio-right channel digital signal to a microphone port of the external plug; or
output a second feeder voltage to the external plug to control the stereo headset to output the mono analog signal to the microphone port.

16. The terminal according to claim 15, further comprising:
a digital-to-analog conversion module configured to perform digital-to-analog conversion on the audio-left channel digital signal and the audio-right channel digital signal to obtain a corresponding audio-left channel analog signal and audio-right channel analog signal; and
a second selection module configured to output the audio-left channel analog signal and the audio-right channel analog signal to an audio-left channel port and an audio-right channel port of the external plug.

17. The terminal according to claim 16, further comprising:
a speech signal processing module configured to perform adaptive noise cancellation, adaptive echo cancellation, and signal enhancement on the audio-left channel analog signal and the audio-right channel analog signal; and
wherein the second selection module is further configured to output the audio-left channel analog signal and the audio-right channel analog signal that undergone the adaptive noise cancellation, adaptive echo cancellation, and signal enhancement.

18. An audio signal processing method based on a stereo headset and a terminal adapted to the stereo headset, the stereo headset comprising a left-ear headset unit, a right-ear headset unit, and an external plug configured to connect to an external terminal, the external plug comprises a microphone port, the left-ear headset unit comprises an audio-left channel microphone and an audio-left channel headset, the right-ear headset unit comprises an audio-right channel microphone and an audio-right channel headset, the terminal comprises an external jack configured to connect to the external plug of the stereo headset, the external jack comprises a microphone interface, and the processing method comprises:
sampling and holding, by the stereo headset in a time sharing manner, an audio-left channel analog signal output by the audio-left channel microphone and an audio-right channel analog signal output by the audio-right channel microphone;
performing, by the stereo headset, analog-to-digital conversion on the audio-left channel analog signal and audio-right channel analog signal that are sampled and held, so as to obtain a corresponding audio-left channel digital signal and a corresponding audio-right channel digital signal;
performing, by the stereo headset, data encapsulation on the audio-left channel digital signal and the audio-right channel digital signal to obtain a serial digital signal;
transmitting, by the stereo headset, the serial digital signal to the terminal by using the microphone port of the external plug;
receiving, by the terminal by using the microphone interface of the external jack, an input signal transmitted by the stereo headset, wherein the input signal is a mono analog signal or a serial digital signal comprising an audio-left channel digital signal and an audio-right channel digital signal; and
demodulating, by the terminal, the input signal to obtain the audio-left channel digital signal and the audio-right channel digital signal that are comprised in the serial digital signal.

19. The audio signal processing method according to claim 18, wherein:
the stereo headset further comprises a mono microphone; and
transmitting the serial digital signal to the external terminal by using the microphone port of the external plug comprises:
detecting, by the stereo headset, a feeder voltage of the external terminal at the external plug,
transmitting the serial digital signal to the external terminal by using the microphone port of the external plug when a first feeder voltage is detected, and
transmitting a mono analog signal output by the mono microphone to the external terminal by using the microphone port of the external plug when a second feeder voltage is detected.

20. The audio signal processing method according to claim 18, wherein before demodulating the input signal, the method comprises:
identifying whether the input signal is the serial digital signal comprising the audio-left channel digital signal and the audio-right channel digital signal or the mono analog signal;
performing the step of demodulating the input signal when it is identified that the input signal is the serial digital signal; and
performing analog-to-digital conversion on the mono analog signal to obtain a mono digital signal when it is identified that the input signal is the mono analog signal.
